(19) United States
(12) Patent Application Publication
(10) Pub. No.: US 2006/0283248 A1
(43) Pub. Date: Dec. 21, 2006

(54) SEMICONDUCTOR SENSOR AND METHOD OF MANUFACTURING THE SAME

(75) Inventors: Takayuki Sugano, Yamagata (JP); Masahiro Sato, Yamagata (JP); Toshiaki Mitsui, Yamagata (JP); Yoshiyuki Watanabe, Yamagata (JP); Takashi Mineta, Aomori (JP)

Correspondence Address: MARGER JOHNSON & MCCOLLOM, P.C., 210 SW MORRISON STREET, SUITE 400, PORTLAND, OR, 97204, US

(73) Assignee: MITSUMI ELECTRIC CO, LTD., Tokyo (JP)

(21) Appl. No.: 11/277,723

(22) Filed: Mar. 28, 2006

(30) Foreign Application Priority Data
Mar. 30, 2005 (JP) 2005-99247

(51) Int. Cl. G01P 15/09

(52) U.S. Cl. 73/514.34; 73/514.16

(57) ABSTRACT

A semiconductor sensor 1 includes: a frame 21 having an opening; an actuation diaphragm 16 provided inside the frame 21 in a spaced-apart relationship with respect to the frame 21; a plurality of flexible beams 19a, 19b provided to interconnect the frame 21 and the actuation diaphragm 16, each of the flexible beams 19a, 19b having piezo resistance elements 30a, 30b, 30c thereon; metallic wiring lines 33 provided on one major surfaces of the respective flexible beams 19a, 19b for connecting each of the piezo resistance elements 30a, 30b, 30c to each other; and a plurality of thermal stress absorbing portions provided on the other major surfaces of the respective flexible beams 19a, 19b for absorbing thermal stresses developed in the beams 19a, 19b due to the difference of coefficients of thermal expansion between the respective beams 19a, 19b and the corresponding metallic wiring lines 33.

### CROSS-REFERENCE TO RELATED APPLICATION

This application claims priority to Japanese Patent Application No. 2005-99247 filed Mar. 30, 2005, which is hereby expressly incorporated by reference herein in its entirety.

### BACKGROUND OF THE INVENTION

1. Field of the Invention

The present invention is related to a semiconductor sensor and a method of manufacturing a semiconductor sensor.

2. Description of the Prior Art

Conventionally, as one example of semiconductor sensors, a triaxial (3-axis) acceleration sensor is known that can detect acceleration in 3-axis directions, for example. The 3-axis acceleration sensor known in the art includes: a support frame of substantially rectangular shape made of silicon; a plurality of thin beams with flexibility provided inside the support frame; an actuation diaphragm (often including a weight member) oscillatably supported by the plurality of beams; and a plurality of bridge circuits constituted from piezo resistance elements respectively disposed on the beams and interconnected by metallic wiring lines.

In this type of 3-axis acceleration sensor, the actuation diaphragm oscillates as the 3-axis acceleration sensor is accelerated in a predetermined direction, in response to which the beams are subject to elastic deformation. This changes the resistance value of each of the piezo resistance elements, thereby varying the output voltages generated by the bridge circuits. Therefore, by sensing the variation of the output voltages, the 3-axis acceleration sensor can detect the acceleration applied.

As another example of the semiconductor sensors, a pressure sensor is also known that has the same configuration as the afore-mentioned 3-axis acceleration sensor but serves to detect the load applied to the actuation diaphragm.

In the meantime, Japanese Patent Laid-open Publication No. HEI. 7-234242 discloses a 3-axis acceleration sensor of the type having thin films made of oxide silicon or nitride silicon provided on the opposite surfaces of respective beams for the purpose of avoiding any warpage or distortion of the beams which would otherwise occur due to the heat applied to the 3-axis acceleration sensor in the manufacturing process thereof.

By the way, the 3-axis acceleration sensor taught in the '242 publication has metallic wiring lines, on one major surfaces of the respective beams, whose coefficient of thermal expansion drastically differs from that of the thin films made of oxide silicon or nitride silicon. For this reason, thermal stresses may be developed in the beams depending on the usage environmental temperature, thereby resulting in such an instance that the beams are deformed even when no load or acceleration is applied to the beams. In this case, in spite of the fact that no load or acceleration acts on the semiconductor sensor, the output voltages generated from a plurality of bridge circuits are unintentionally changed from a zero offset, which poses a problem in that acceleration or load cannot be detected in a precise and accurate manner.

### SUMMARY OF THE INVENTION

Taking the above-mentioned and other problems into account, it is an object of the present invention to provide a semiconductor sensor and a method of manufacturing a semiconductor sensor that can absorb thermal stresses developed in beams due to the difference of coefficients of thermal expansion between the beams and metallic wiring lines, thereby preventing any inadvertent deformation of the beams.

In order to achieve the object, in one aspect of the present invention, the invention is directed to a semiconductor sensor. The semiconductor sensor of the present invention includes:

a frame having an opening;

an actuation diaphragm provided inside the frame in a spaced-apart relationship with respect to the frame;

a plurality of flexible beams provided to interconnect the frame and the actuation diaphragm, each of the flexible beams having piezo resistance elements thereon;

metallic wiring lines provided on one major surfaces of the respective flexible beams for connecting each of the piezo resistance elements to each other; and

a plurality of thermal stress absorbing portions provided on the other major surfaces of the respective flexible beams for absorbing thermal stresses developed in the beams due to the difference of coefficients of thermal expansion between the respective beams and the corresponding metallic wiring lines.

According to the semiconductor sensor having the configuration as described above, by providing the thermal stress absorbing portions on the other major surfaces of the respective flexible beams, the semiconductor sensor can prevent the beams from deforming attributable to the thermal stresses that may be developed in the beams due to the difference of coefficients of thermal expansion between the respective beams and the corresponding metallic wiring lines. This enables the semiconductor sensor to accurately detect physical quantities, such as acceleration, pressure and the like, which are measurable by the semiconductor sensor.

Further, in the semiconductor sensor of the present invention, it is preferable that each of the thermal stress absorbing portions comprises a film whose thickness is selected depending on a wiring pattern and a volume of the wiring lines in each of the beams.

By controlling the thickness of the film in this manner, it becomes possible to adapt the film to different wiring patterns of the metallic wiring lines and different kinds of metals and volumes of the metal used in forming the metallic wiring lines.

Moreover, in the semiconductor sensor of the present invention, it is preferable that the film is formed of a member selected from the group including metal, metal oxide and metal nitride.

This makes it possible to assure proper selection of a material for the film.

Furthermore, in the semiconductor sensor of the present invention, it is preferable that the semiconductor further includes a weight member bonded to one major surface of the actuation diaphragm, wherein, in the case where the semiconductor sensor is subject to acceleration, the actuation diaphragm and the weight member are displaced as a unit in response to the acceleration, and the semiconductor sensor is adapted to detect the acceleration based on the resistance values of the piezo resistance elements which vary with the amount of displacement of the actuation diaphragm and the weight member.

This makes it possible to precisely detect the acceleration given to the semiconductor sensor.

Further, in the semiconductor sensor of the present invention, it is preferable that, in the case where the actuation diaphragm receives a load, the actuation diaphragm is displaced in proportion to the magnitude of the load received, and the semiconductor sensor is adapted to detect the load based on the resistance values of the piezo resistance elements which vary with the amount of displacement of the actuation diaphragm.

This makes it possible to precisely detect the load exerted on the actuation diaphragm of the semiconductor sensor.

Further, in another aspect of the present invention, the invention is directed to a method of manufacturing a semiconductor sensor. The method of the present invention includes:

preparing a semiconductor substrate;

forming a plurality of piezo resistance elements on one major surface of the semiconductor substrate;

forming an actuation diaphragm by subjecting the semiconductor substrate to an etching process from the other major surface of the semiconductor substrate;

forming metallic wiring lines on the one major surface of the semiconductor substrate to connect each of the piezo resistance elements to each other;

removing a part of the semiconductor substrate to form a frame outside the actuation diaphragm in a spaced-apart relationship with respect to the actuation diaphragm and a plurality of flexible beams for interconnecting the actuation diaphragm and the frame, each of the flexible beams having a plurality of piezo resistance elements formed on one major surfaces of the corresponding flexible beam; and

forming thermal stress absorbing portions on the other major surfaces of the respective flexible beams, the thermal stress absorbing portions being adapted to absorb thermal stresses developed in the beams due to the difference of coefficients of thermal expansion between the respective beams and the corresponding metallic wiring lines.

According to the method of manufacturing a semiconductor sensor including the steps as described above, it is possible to manufacture a semiconductor sensor capable of effectively preventing deformation of the beams attributable to the thermal stresses that may be developed in the beams due to the difference of coefficients of thermal expansion between the respective beams and the corresponding metallic wiring lines. Therefore, it is possible to provide the method of manufacturing a semiconductor sensor that can accurately detect physical quantities, such as acceleration, pressure and the like, which are measurable by the semiconductor sensor.

Further, in the method of the present invention, it is preferable that the step of forming the thermal stress absorbing portions comprises the steps of:

forming a film on the other major surface of the semiconductor substrate in which the actuation diaphragm, the beams and the frame have been formed, the film being formed of a member selected from the group including metal, metal oxide and metal nitride; and

removing the film formed on the actuation diaphragm and the frame.

This makes it possible to form the film just on the other major surfaces of the beams.

Moreover, in the method of the present invention, it is preferable that the step of forming the film comprises one coating method selected from the group including a sputtering method, a vapor deposition method and a chemical vapor deposition method.

This helps to readily control the thickness of the film formed on the actuation diaphragm, the beams and the frame.

Furthermore, in the method of the present invention, it is preferable that the step of removing the film comprises an etching process.

This makes it possible to clearly remove the film formed on the other major surfaces of the actuation diaphragm and the frame with accuracy while the film leaving on the bottom major surfaces of the beams intact.

Further, in the method of the present invention, it is preferable that the method further includes the steps of:

bonding a glass substrate or a metal substrate to the other major surface of the semiconductor substrate after the step of forming the thermal stress absorbing portions; and

removing a part of the glass substrate or the metal substrate to form the frame and a weight member suspended from the plurality of flexible beams via the actuation diaphragm.

The semiconductor sensor manufactured by the method of the present invention allows the actuation diaphragm and the weight member to displace as a unit. This means that the weight (heaviness) of the weight member can be increased in case of using the semiconductor sensor thus manufactured as a 3-axis acceleration sensor. Accordingly, it becomes possible to manufacture a semiconductor sensor that can quite accurately detect the acceleration applied to the semiconductor sensor.

### BRIEF DESCRIPTION OF THE DRAWINGS

The foregoing and other objects, features and advantages of the present invention will become more readily apparent from the following detailed description of a preferred embodiment of the present invention given in conjunction with the accompanying drawings, in which:

FIG. 1 is a perspective view which shows a semiconductor sensor in accordance with the present invention;

FIG. 2 is a top view of the semiconductor sensor shown in FIG. 1,

FIG. 3 is a cross-sectional view of the semiconductor sensor shown in FIG. 1;

FIG. 4 is an exploded perspective view of a 3-axis acceleration sensor that is one embodiment of a semiconductor sensor in accordance with the present invention;

FIG. 5 is a vertical cross-sectional view which illustrates steps of manufacturing the 3-axis acceleration sensor shown in FIG. 4;

FIG. 6 is a vertical cross-sectional view which illustrates steps of manufacturing the 3-axis acceleration sensor shown in FIG. 4;

FIG. 7 is a vertical cross-sectional view which illustrates steps of manufacturing the 3-axis acceleration sensor shown in FIG. 4;

FIG. 8 is a vertical cross-sectional view which illustrates steps of manufacturing the 3-axis acceleration sensor shown in FIG. 4;

FIG. 9 is a vertical cross-sectional view which illustrates steps of manufacturing the 3-axis acceleration sensor shown in FIG. 4; and

FIG. 10 is a graphical representation which shows the beneficial effects provided by thermal stress absorbing portions of a semiconductor sensor in accordance with the present invention.

### DETAILED DESCRIPTION OF THE INVENTION

Hereinafter, preferred embodiments of a semiconductor sensor and a method of manufacturing the same according to the invention will be described with reference to the appended drawings. First, the configuration of the semiconductor sensor according to the present invention will be described.

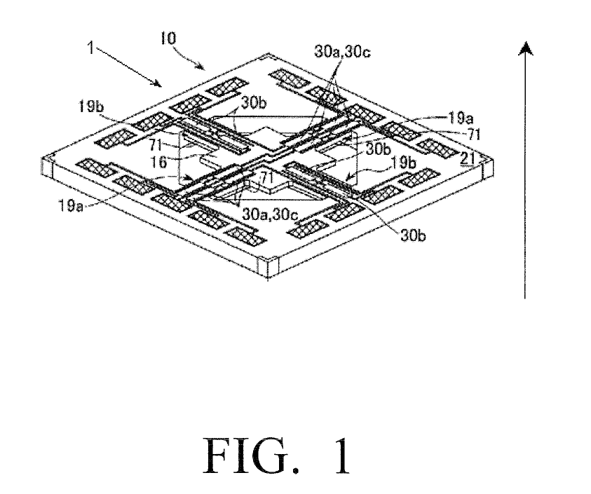

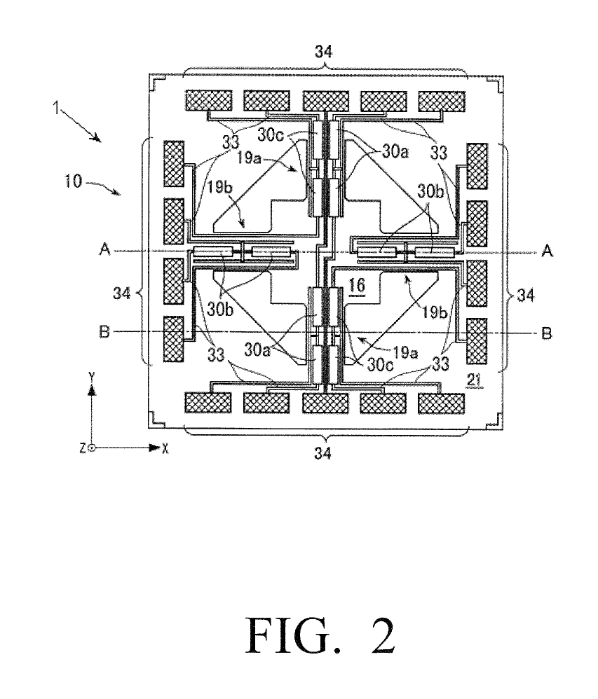

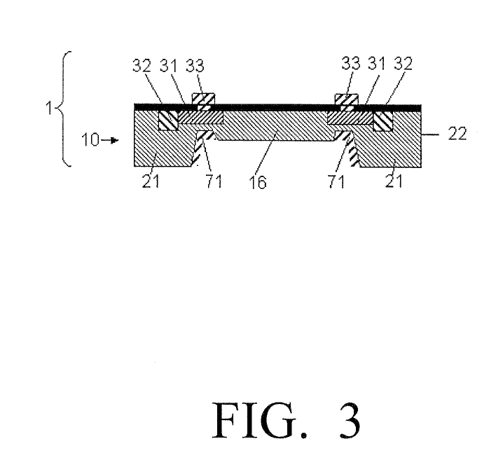

FIG. 1 is a perspective view which shows a semiconductor sensor in accordance with the present invention; FIG. 2 is a top view of the semiconductor sensor shown in FIG. 1; FIG. 3 is a cross-sectional view of the semiconductor sensor shown in FIG. 1 taken along line A-A in FIG. 2. In this regard, as used herein, the term “top” or its equivalents refers to the direction indicated by an arrow in FIG. 1, whereas the term “bottom” or its equivalents refers to the opposite direction of the arrow.

Referring to FIG. 1, a semiconductor sensor 1 of the present invention is constructed from a silicon substrate 10. The silicon substrate 10 includes: a silicon frame 21 having an opening; an actuation diaphragm 16 provided inside the silicon frame 21 in a spaced-apart relationship with respect to the silicon frame 21; four flexible beams 19a, 19b provided to interconnect the silicon frame 21 and the actuation diaphragm 16 in which each of the flexible beams 19a, 19b has piezo resistance elements 30a, 30b, 30c; aluminum (metallic) wiring lines 33 provided on one major surfaces of the four flexible beams 19a, 19b for connecting each of the piezo resistance elements 30a, 30b, 30c to each other; and four thermal stress absorbing portions 71 (see FIG. 3) provided on the other major surfaces of the four flexible beams 19a, 19b for absorbing thermal stresses developed in the beams 19a, 19b due to the difference of coefficients of thermal expansion between the respective beams 19a, 19b and the corresponding aluminum wiring lines 33.

The thermal stress absorbing portions 71 serve to absorb the thermal stresses that may be developed in the beams 19a, 19b due to the difference of coefficients of thermal expansion between the respective beams 19a, 19b and the corresponding aluminum wiring lines 33. According to the present invention, by providing the thermal stress absorbing portions 71 in the semiconductor sensor 1, it becomes possible to effectively prevent deformation of the beams 19a, 19b when no physical quantity (for example, load, acceleration or the like) targeted for detection is applied to the actuation diaphragm 16.

In this case, it is preferable that each of the thermal stress absorbing portions 71 is formed with a film whose thickness is selected depending on wiring patterns, kind of metal and volumes of the aluminum (metallic) wiring lines 33. As set forth later, it is preferable that the film is made of one of metal, metal oxide and metal nitride.

Now, description will be given for the configuration of the top major surface of the semiconductor sensor 1 in accordance with the present invention. As can be seen in FIG. 2, the actuation diaphragm 16 has a generally rectangular shape and is formed at the center of the silicon substrate 10. The four beams 19a, 19b extend from the substantially middle points of four sides of the actuation diaphragm 16 toward the substantially middle points of four sides of the silicon frame 21 in a one-to-one correspondence and are connected to the corresponding sides of the silicon frame 21. Each of the beams 19a, 19b has flexibility as described above. Two pairs of piezo resistance elements 30a, 30c are formed on each of the beams 19a, while one pair of piezo resistance elements 30b is formed on each of the beams 19b.

According to the semiconductor sensor 1 of the present invention, the piezo resistance elements 30a, 30c formed on the beams 19a are adapted to detect the forces applied to the actuation diaphragm 16 in X-axis and Z-axis directions in the rectangular coordinate system shown in FIG. 2, respectively. On the other hand, the piezo resistance elements 30b formed on the beams 19b are adapted to detect the forces applied to the actuation diaphragm 16 in a Y-axis direction.

As set forth above, the piezo resistance elements 30a, 30b, 30c are connected to each other by means of the aluminum wiring lines 33. The aluminum wiring lines 33 are also connected to a plurality of aluminum pads 34 lying adjacent to the peripheral edges of the silicon frame 21. As best shown in FIG. 2, the total number of the aluminum pads 34 is eighteen, including four or five ones disposed along the respective sides of the silicon frame 21. The piezo resistance elements 30a, 30b, 30c, the aluminum wiring lines 33 and the aluminum pads 34 cooperate to constitute three bridge circuits that serve a sensor to detect the forces (the physical quantities such as load, acceleration and the like) acting in the 3-axis directions, respectively. In this case, the aluminum pads 34, which serve as top-most vertices of the three, X-, Y-, Z-direction bridge circuits, are grouped on a facing pad basis and connected to the output terminals of an amplifying circuit (amplifier) or a temperature compensation circuit or to input voltage (Vcc) terminals (not shown in the drawings).

Next, operation of the semiconductor sensor 1 in accordance with the present invention will now be described in detail.

In the case where force is applied to the actuation diaphragm 16 of the semiconductor sensor 1, the beams 19a, 19b are elastically deformed and the resistance values of the piezo resistance elements 30a, 30b, 30c formed on the beams 19a, 19b vary with the displacement of the actuation diaphragm 16 of the semiconductor sensor 1. This results in variation of the output voltages of the three bridge circuits constituted from the piezo resistance elements 30a, 30b, 30c, the aluminum wiring lines 33 and the aluminum pads 34. The semiconductor sensor 1 of the present invention can detect the force applied to the actuation diaphragm 16 of the semiconductor sensor 1 by detecting such voltage variation.

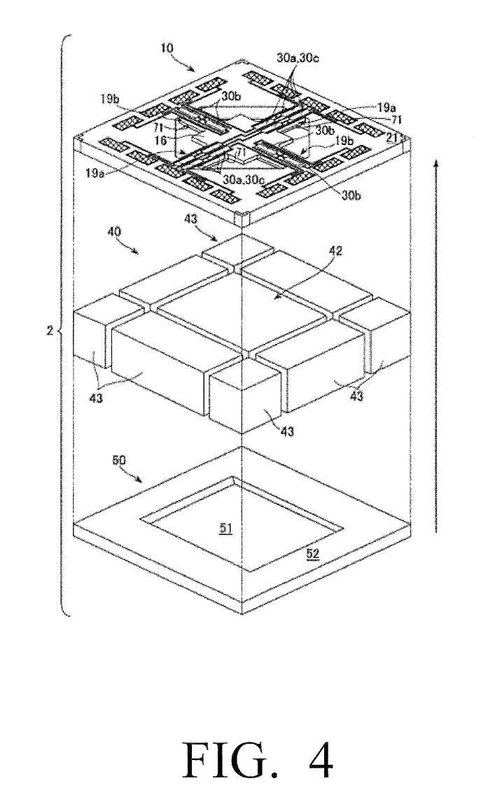

In particular, the semiconductor sensor 1 of the present invention can play a role of a pressure sensor that detects a pressure at the time when the pressure (load) is applied to the actuation diaphragm 16. Further, by virtue of bonding a weight member 42 (see FIG. 4) to the actuation diaphragm 16 as will be set forth later, the semiconductor sensor 1 of the present invention can play a role of an acceleration sensor that detects acceleration when the acceleration is applied to the semiconductor sensor 1.

Hereinafter, the semiconductor sensor 1 of the present invention will be described in detail with regard to a 3-axis acceleration sensor 2 which is an embodiment of the semiconductor sensor 1. In this regard, the following description will be centered on an instance that the weight member 42 is bonded to one major surface of the actuation diaphragm 16 in order to detect, with increased sensitivity, the acceleration applied to the 3-axis acceleration sensor 2. In this case, in view of the fact that the actuation diaphragm 16 serves to support the weight member 42, the actuation diaphragm 16 will be referred to as a weight member supporting portion 16 in the following description of the 3-axis acceleration sensor 2.

FIG. 4 is an exploded perspective view of the 3-axis acceleration sensor 2 that is one embodiment of the semiconductor sensor 1 in accordance with the present invention. In this regard, as used herein, the term “top” or its equivalents refers to the direction indicated by an arrow in FIG. 4, whereas the term “bottom” or its equivalents refers the opposite direction of the arrow.

As shown in FIG. 4, the 3-axis acceleration sensor 2, one embodiment of the semiconductor sensor 1 in accordance with the present invention, includes a silicon substrate 10 serving as a semiconductor substrate, a glass substrate 40 serving as a bottom substrate, and a base 50.

The silicon substrate 10 includes: a silicon frame (a part of a frame) 21 having an opening; a weight member supporting portion 16 provided inside the silicon frame 21 in a spaced-apart relationship with respect to the silicon frame 21 for supporting a weight member 42 composed of a part of a glass substrate 40; four flexible beams 19a, 19b provided to interconnect the silicon frame 21 and the weight member supporting portion 16 in which the respective flexible beams 19a, 19b have piezo resistance elements 30a, 30b, 30c on their top major surfaces (one major surfaces); aluminum (metallic) wiring lines 33 (see FIG. 2) provided on the top major surfaces (one major surfaces) of the four flexible beams 19a, 19b for connecting each of the piezo resistance elements 30a, 30b, 30c to each other; and four thermal stress absorbing portions 71 respectively provided on the bottom major surfaces (the other major surfaces) of the four flexible beams 19a, 19b for absorbing thermal stresses developed in the beams 19a, 19b due to the difference of coefficients of thermal expansion between the respective beams 19a, 19b and the corresponding aluminum wiring lines 33.

Further, in the present embodiment, the glass substrate 40 is formed of a Pyrex® glass. The glass substrate 40 includes a weight member 42, and eight glass frames (a part of the frame) 43 disposed around and outside the weight member 42 in a spaced-apart relationship with respect to the weight member 42.

Moreover, in the present embodiment, the base 50 is made of silicon. The base 50 includes a bonding portion 52 having a substantially rectangular ring-shape to be bonded to the bottom major surfaces of the eight glass frames 43 of the glass substrate 40, and a concave portion 51 having a substantially rectangular shape defined by the ring-shaped bonding portion 52. The concave portion 51 is so sized and arranged that it can prevent physical interference with the weight member 42 when components of the 3-axis acceleration sensor 2 are assembled together.

The top major surface of the silicon substrate 10 of the 3-axis acceleration sensor 2 has the same configuration as that of the semiconductor sensor 1 set forth above. Further, as with the semiconductor sensor 1, the thermal stress absorbing portions 71 described above are formed on the bottom major surfaces of the beams 19a, 19b of the silicon substrate 10. There is a possibility that the 3-axis acceleration sensor 2 may be broken if the weight member 42 makes contact with the bottom major surface of any of the beams 19a, 19b in the course of oscillating movement of the weight member 42 and the weight member supporting portion 16 as a unit. In order to avoid such a possibility, it is preferable that the weight member supporting portion 16 has a greater thickness than that of the actuation diaphragm 16 employed in the semiconductor sensor 1 described above. By bonding the weight member 42 to the bottom major surface of the weight member supporting portion 16 having such an increased thickness, the weight member 42 and the weight member supporting portion 16 can be displaced to an extent great enough to precisely detect the acceleration applied. In the following description, it should be understood that the weight member supporting portion 16 has a greater thickness than that of the actuation diaphragm 16 as described above.

According to the 3-axis acceleration sensor 2, the piezo resistance elements 30a, 30c formed on the beams 19a are adapted to detect the acceleration in X-axis and Z-axis directions in the rectangular coordinate system shown in FIG. 2. On the other hand, the piezo resistance elements 30b formed on the beams 19b are adapted to detect the acceleration in a Y-axis direction.

If acceleration is applied to the 3-axis acceleration sensor 2 having such a configuration, the weight member supporting portion 16 and the weight member 42 supported by the weight member supporting portion 16 oscillate as a unit. In response, the beams 19a, 19b are elastically deformed and the resistance values of the piezo resistance elements 30a, 30b, 30c formed on the beams 19a, 19b vary with the acceleration applied to the 3-axis acceleration sensor 2. This results in variation of the output voltages of the bridge circuits constituted from the piezo resistance elements 30a, 30b, 30c, the aluminum wiring lines 33 and the aluminum pads 34. Thus, the 3-axis acceleration sensor 2 can detect the acceleration applied to the 3-axis acceleration sensor 2 by detecting such voltage variation.

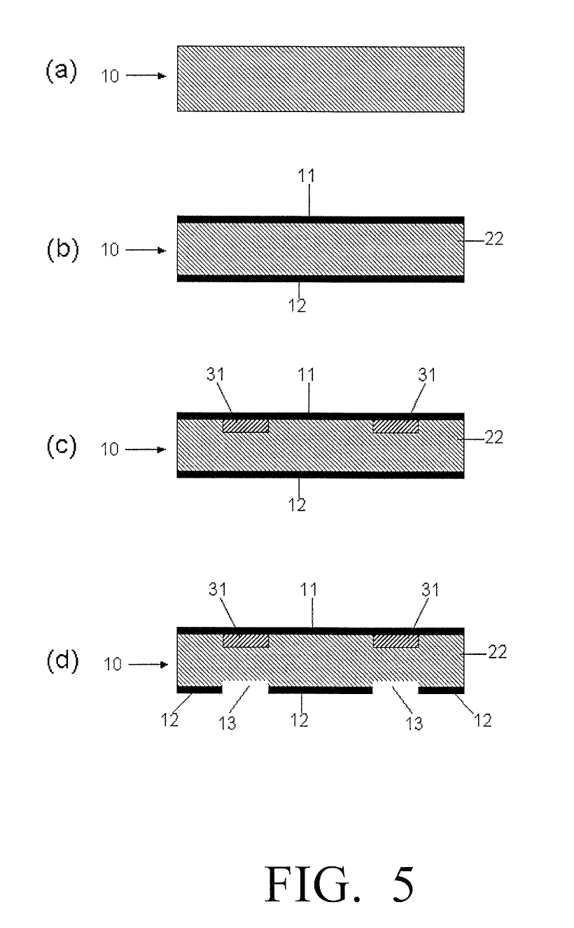

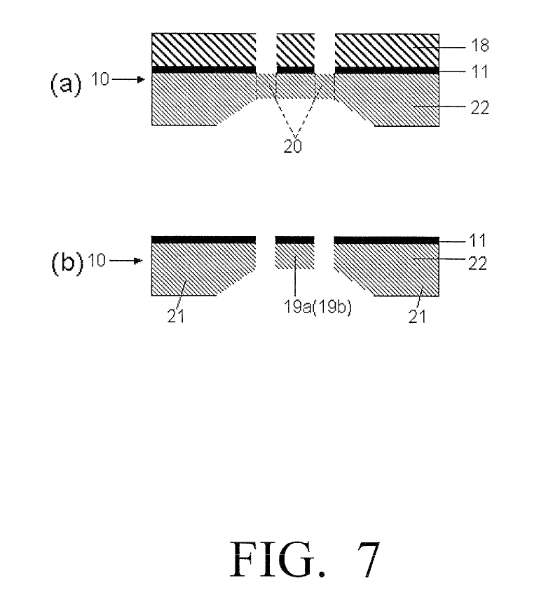

Next, description will now be given for one example of the method of manufacturing the 3-axis acceleration sensor 2 of the present embodiment using FIGS. 5 through 9. FIGS. 5 through 9 are vertical cross-sectional views which illustrates steps of manufacturing the 3-axis acceleration sensor 2 shown in FIG. 4. Among these drawings, FIGS. 5, 6, 8 and 9 are vertical cross-sectional views taken along line A-A in FIG. 2, whereas FIG. 7 is a cross-sectional view taken along line B-B in FIG. 2.

First, a silicon substrate 10 is prepared as shown in FIG. 5(a). In the present embodiment, the silicon substrate 10 has a thickness of about 200 μm.

The silicon substrate 10 is heated in an oxidizing atmosphere so that the top and bottom major surfaces of the silicon substrate 10 can be oxidized as illustrated in FIG. 5(b). Thus, silicon oxide layers 11, 12 are formed on the top and bottom major surfaces of the silicon substrate 10, respectively. As used herein, the term “silicon layer 22” refers to a part of the silicon substrate 10 that has not been oxidized. In this regard, in the present embodiment, it is preferable that a thickness of each of the silicon oxide layers 11, 12 is in the range of about 0.5 to 3.0 μm.

Next, impurities (boron in the present embodiment) are injected into the silicon substrate 10 from the side on which the silicon oxide layer 11 lies. Then, by subjecting the silicon substrate 10 to thermal treatment, the impurities are dispersed through the silicon layer 22. Thus, a plurality of first piezo resistance regions 31 are formed in the silicon layer 22 in the vicinity of an interfacial boundary of the silicon layer 22 and the silicon oxide layer 11, as illustrated in FIG. 5(c).

Subsequently, parts of the silicon oxide layer 12 that correspond to the first piezo resistance regions 31 thus formed as described above are removed from the bottom major surface of the silicon substrate 10 by subjecting the silicon substrate 10 to an etching process. In addition, the parts of the silicon layer 22 from which the silicon oxide layer 12 has been removed are further etched to form concave portions 13 as illustrated in FIG. 5(d).

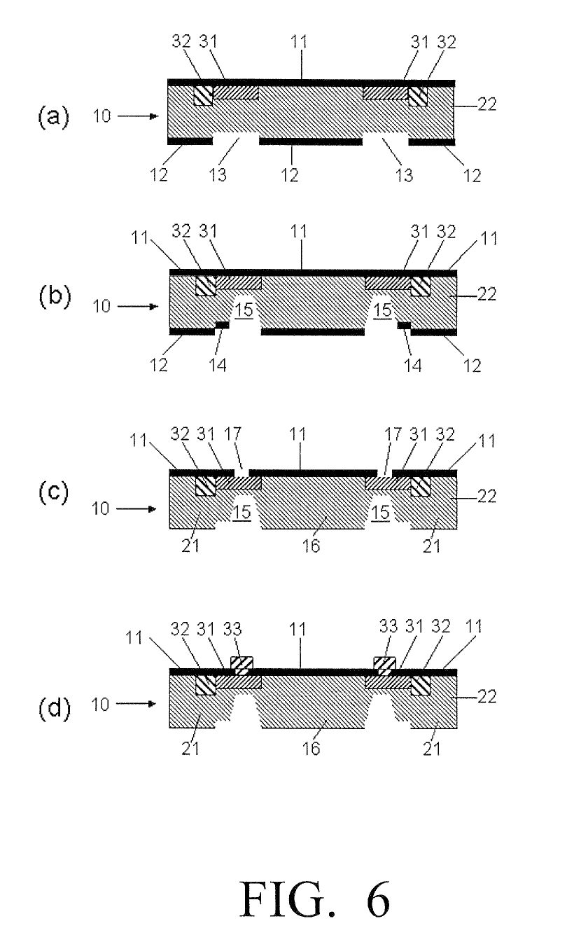

Thereafter, impurities are once again injected into the silicon substrate 10 from the side on which the silicon oxide layer 11 lies. Then, by subjecting the silicon substrate 10 to thermal treatment, the impurities are dispersed through the silicon layer 22. In this case, at the parts adjoining the first piezo resistance regions 31, that is, at the outer sides of the first piezo resistance regions 31 in FIG. 6(a), a plurality of second piezo resistance regions 32 are formed in the silicon layer 22 in the vicinity of the interfacial boundary of the silicon layer 22 and the silicon oxide layer 11. As can be seen in FIG. 6(a), the second piezo resistance regions 32 are formed in contact with (or so as to abut on) the outer side surfaces of the first piezo resistance regions 31. It should be noted that the concentration of impurities in the second piezo resistance regions 32 is greater than that in the first piezo resistance regions 31. In this regard, each of the piezo resistance elements 30a, 30b, 30c described above are constituted from the first piezo resistance regions 31 or the second piezo resistance regions 32.

Then, by subjecting the silicon substrate 10 to thermal treatment, silicon oxide layers 14 are formed on the partial areas of the concave portions 13. Thereafter, the silicon substrate 10 is subjected to an etching process so that the limited parts of the silicon layer 22 which has not been covered by the silicon oxide layers 12 or 14 are removed, thereby forming concave portions 15 of trapezoidal shape in section, as illustrated in FIG. 6(b).

Subsequently, as illustrated in FIG. 6(c), the silicon oxide layers 12, 14 are removed from the bottom major surface of the silicon substrate 10. Thus, a weight member supporting portion 16 is formed substantially on the bottom center area of the silicon layer 22, which can support a weight member 42 at the bottom major surface of the silicon substrate 10. Further, in this process, a silicon frame 21 is also formed that lies outside the weight member supporting portion 16, and faces the weight member supporting portion 16 with the trapezoidal concave portions 15 interposed therebetween.

Further, as illustrated in FIG. 6(c), a plurality of contact holes 17 are formed through the silicon oxide layer 11 on the top major surface of the silicon substrate 10 in such a manner that the contact holes 17 lead to the first piezo resistance regions 31.

Thereafter, an aluminum layer is vapor-deposited on the top major surface of the silicon oxide layer 11. By subjecting the aluminum layer to an etching process after carrying out patterning on the aluminum layer thus deposited, aluminum (metallic) wiring lines 33 and aluminum pads 34 (see FIG. 2) are formed. In the present embodiment, as shown in FIG. 6(d), the aluminum wiring lines 33 are connected to the first piezo resistance regions 31 through the contact holes 17.

Subsequently, as can be seen in FIG. 7(a), a resist layer 18 is formed by means of a photolithography method on a predetermined area of the silicon oxide layer 11, that is, on other area than the opening (aperture) in FIG. 2. Then, parts of the silicon oxide layer 11 that has not been covered by the resist layer 18 are removed by means of a dry etching process such as plasma etching or the like.

As illustrated in FIG. 7(b), by subjecting the silicon substrate 10 to a plasma etching process from the side of the top major surface of the silicon substrate 10, the need-to-remove portions 20 (portions of the silicon layer 22 to be removed) shown only in FIG. 7(a) are removed. Thus, a plurality of beams 19a, 19b that interconnect the weight member supporting portion 16 and the silicon frame 21 are formed. Each of the beams 19a, 19b has a thickness of about 14 μm which is smaller than the thickness of the silicon frame 21.

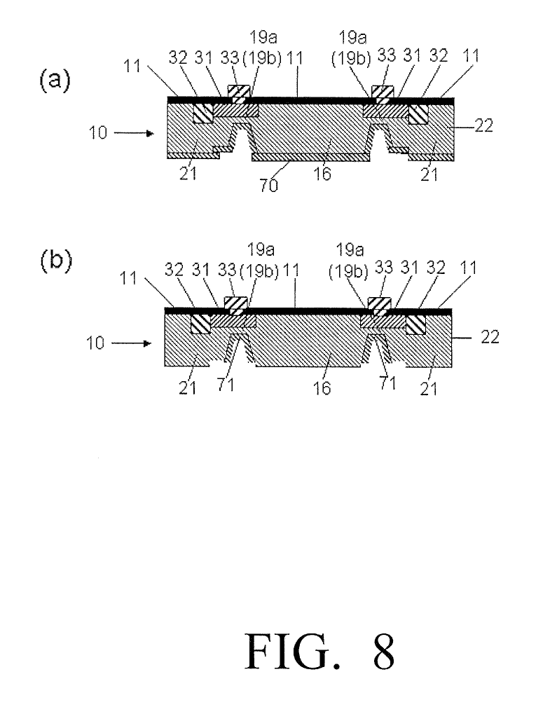

Subsequently, as illustrated in FIG. 8(a), an aluminum film 70 is coated on the bottom major surface of the silicon substrate 10 by means of a sputtering method or a vapor deposition method. In the present embodiment, it is preferable that the aluminum film 70 has a thickness of about 0.15 μm.

Thereafter, the film 70 formed on bottom major surface of the weight member supporting portion 16, the silicon frame 21 and the recesses 13 are removed by means of an etching process. Thus, parts of the film 70 intact only on the bottom major surfaces of the beams 19a, 19b are left, as can be seen in FIG. 8(b). These parts of the film 70 constitute thermal stress absorbing portions 71 in the present invention. The thermal stress absorbing portions 71 help to prevent deformation of the respective beams 19a, 19b in a state where no load or acceleration is applied to the 3-axis acceleration sensor 2.

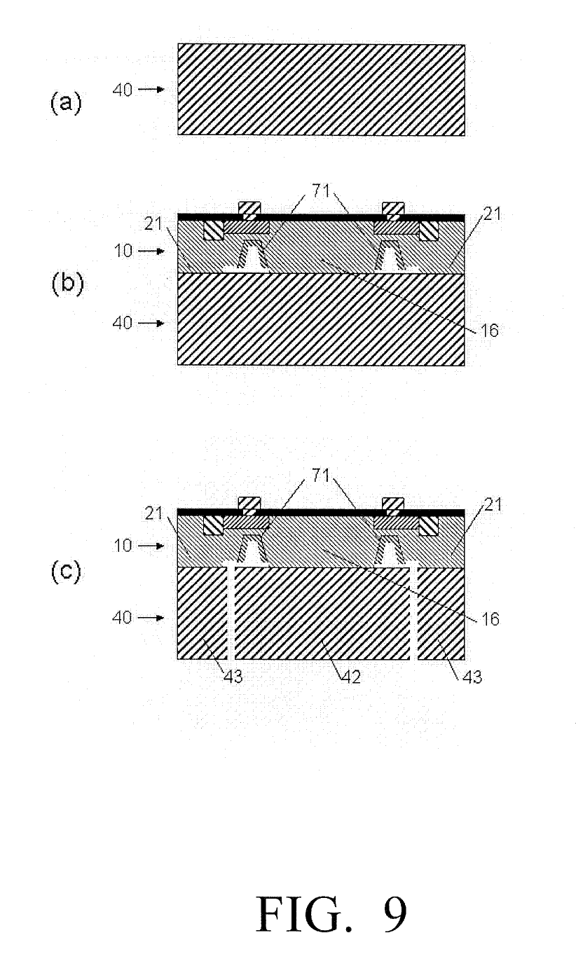

In addition, a glass substrate 40 made of Pyrex glass is prepared as illustrated in FIG. 9(a). The glass substrate 40 has a thickness of about 1,000 μm in the present embodiment.

Next, as illustrated in FIG. 9(b), the silicon substrate 10 thus formed as described above are anode-bonded to the glass substrate 40 together under the state where the bottom major surfaces of the weight member supporting portion 16 and the silicon frame 21 of the silicon substrate 10 as described above are brought into contact with one major surface of the glass substrate 40.

Subsequently, as illustrated in FIG. 9(c), the glass substrate 40 is diced in an upward direction in FIG. 9(c) from the bottom major surface side of the glass substrate 40, thus removing parts of the glass substrate 40. In this case, as shown in FIG. 4, the dicing for the glass substrate 40 is carried out along four straight lines to divide the glass substrate 40 into nine pieces. Among the nine pieces of the glass substrate 40 thus diced, the centrally positioned one plays a role of the weight member 42. The top major surfaces of the eight glass frames 43 disposed around the weight member 42 are bonded to the bottom major surface of the silicon frame 21. This enables the silicon frame 21 and the glass frames 43 to serve as a frame surrounding the weight member supporting portion 16 and the weight member 42 in a spaced-apart relationship therewith.

Next, abase 50 is prepared. The bottom major surfaces of the eight glass frames 43 are bonded to the bonding portion 52 of the base 50 (see FIG. 4), whereby the 3-axis acceleration sensor 2 of the present embodiment is manufactured finally.

In this regard, the semiconductor sensor 1 shown in FIG. 1 may be manufactured by using the steps of the present embodiment as illustrated in FIGS. 5 through 8. Alternatively, the semiconductor sensor 1 of the cross-sectional shape as shown in FIG. 3 may be manufactured by reducing the thickness of the weight member supporting portion (actuation diaphragm) 16 by means of an etching process or other like treatment.

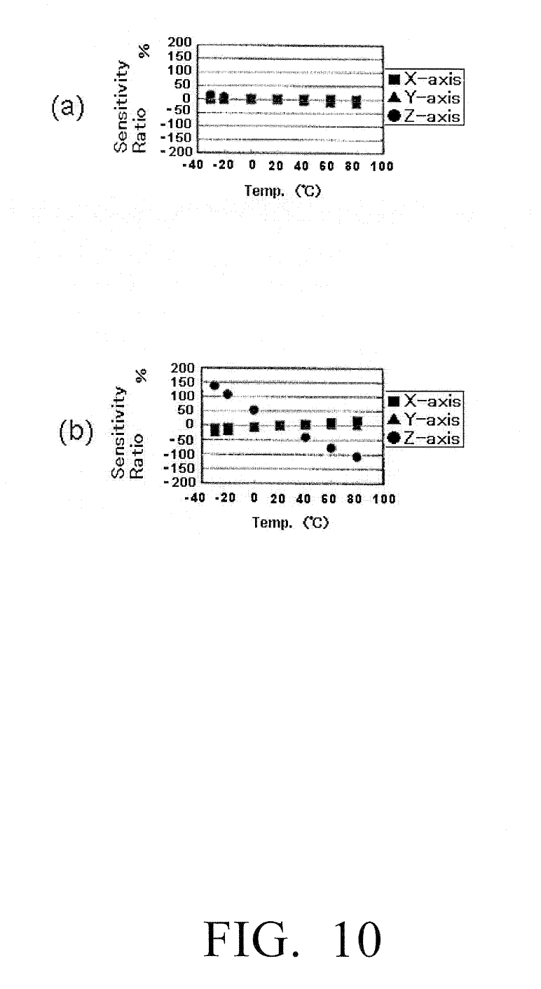

Now, description will be given for the correlation of a temperature and a sensitivity ratio before and after application of the present invention. FIG. 10 shows the correlation of X-axis, Y-axis, and Z-axis sensitivity ratios and a usage environmental temperature in case where the aluminum wiring lines 33 are formed on the top major surfaces of the beams 19a, 19b in a predetermined wiring pattern. In this case, the term “sensitivity ratio” means the ratio between the physical quantities such as acceleration, pressure and the like actually applied to the semiconductor sensor 1 and the output of the semiconductor sensor 1.

More specifically, FIG. 10(a) represents the correlation of respective triaxial sensitivity ratios and a usage environmental temperature in the case where the thermal stress absorbing portions 71, that is, the aluminum film parts, each having a thickness of 0.15 μm are formed on the bottom major surfaces of the beams 19a, 19b. On the contrary, FIG. 10(b) represents the correlation of respective triaxial sensitivity ratios and a usage environmental temperature in the case where no thermal stress absorbing portion is formed on the bottom major surfaces of the beams 19a, 19b, namely, in the case where the present invention is not applied to the semiconductor sensor 1. It can be seen in these figures that the Z-axis sensitivity ratio over the usage environmental temperature is greatly improved when the thermal stress absorbing portions 71 each having a thickness of 0.15 μm are formed on the bottom major surfaces of the beams 19a, 19b.

The 3-axis acceleration sensor 2, which is one embodiment of the semiconductor sensor 1 of the present invention, can be advantageously used as: a sensor for detecting inclination or vibration of each of household electronic appliances and video appearances; a sensor for detecting the posture of potable game devices and game controllers; a security sensor mounted to a window or the like for detecting vibration thereof; a sensor for detecting the posture of robots; a sensor for detecting the posture of players to ascertain (or check) their forms in the field of sports such as golf; a sensor for detecting the dropping of electronic precision equipments; a counting sensor in step counters (that is, a pedometer) and the like.

As described in the foregoing, according to the semiconductor sensor 1 of the present invention, by forming the thermal stress absorbing portions 71 on the bottom major surfaces of the flexible beams 19a, 19b, it is possible to prevent deformation of the beams 19a, 19b attributable to the difference of coefficients of thermal expansion between the respective beams 19a, 19b and the corresponding aluminum (metallic) wiring lines 33.

This enables the semiconductor sensor 1 of the present invention to accurately detect physical quantities such as acceleration, pressure and the like, regardless of the usage environmental temperature.

Although the semiconductor sensor 1 and the method of manufacturing the semiconductor sensor 1 according to the invention has been descried with reference to the preferred embodiment shown in the drawings, the invention is not limited thereto.

For example, in the semiconductor sensor 1 of the present invention although it has been described that the thermal stress absorbing portions 71 are made of aluminum, it should be appreciated that the material for the thermal stress absorbing portions 71 is not limited to aluminum. For example, the material for the thermal stress absorbing portions 71 may include other metal, metal oxide and metal nitride, as long as they are capable of absorbing the thermal stresses developed in the beams 19a, 19b due to the difference of coefficients of thermal expansion between the respective beams 19a, 19b and the aluminum (metallic) wiring lines 33.

Further, in the semiconductor sensor 1 of the present invention, although it has been described that the film 70 is coated by means of a sputtering method or a vapor deposition method, the film coating method is not limited to the sputtering method or the vapor deposition method. For example, the film 70 may be formed by means of a chemical vapor deposition (CVD) method.

Moreover, in the semiconductor sensor 1 of the present invention, although it has been described that the weight member 42 is formed of glass by use of the glass substrate 40, the weight member 42 of the semiconductor sensor 1 is not limited to the one made of glass. For example, the weight member 42 of the semiconductor sensor 1 may be formed of a metal by use of a metal substrate.

Furthermore, in the semiconductor sensor 1 of the present invention, although it has been described that the film 70 formed on the bottom major surfaces of the beams 19a, 19b has a thickness of 0.15 μm, the thickness of the film 70 (that is, the thickness of each of the thermal stress absorbing portions 71) may be properly selected depending on wiring patterns, kind of metal and volumes of the aluminum (metallic) wiring lines 33 formed on the top major surfaces of the beams 19a, 19b.

Although a preferred embodiment of the present invention has been set forth in the foregoing, it will be apparent to those skilled in the art that various changes or modifications may be made thereto within the scope of the invention defined by the claims.

1. A semiconductor sensor, comprising:
a frame having an opening;
an actuation diaphragm provided inside the frame in a spaced-apart relationship with respect to the frame;
a plurality of flexible beams provided to interconnect the frame and the actuation diaphragm, each of the flexible beams having piezo resistance elements thereon;
metallic wiring lines provided on one major surfaces of the respective flexible beams for connecting each of the piezo resistance elements to each other; and
a plurality of thermal stress absorbing portions provided on the other major surfaces of the respective flexible beams for absorbing thermal stresses developed in the beams due to the difference of coefficients of thermal expansion between the respective beams and the corresponding metallic wiring lines.

2. The semiconductor sensor as claimed in claim 1, wherein each of the thermal stress absorbing portions comprises a film whose thickness is selected depending on a wiring pattern and a volume of the wiring lines in each of the beams.

3. The semiconductor sensor as claimed in claim 2, wherein the film is formed of a member selected from the group including metal, metal oxide and metal nitride.

4. The semiconductor sensor as claimed in claim 1, further comprising a weight member bonded to one major surface of the actuation diaphragm, wherein, in the case where the semiconductor sensor is subject to acceleration, the actuation diaphragm and the weight member are displaced as a unit in response to the acceleration, and the semiconductor sensor is adapted to detect the acceleration based on the resistance values of the piezo resistance elements which vary with the amount of displacement of the actuation diaphragm and the weight member.

5. The semiconductor sensor as claimed in claim 1, wherein, in the case where the actuation diaphragm receives a load, the actuation diaphragm is displaced in proportion to the magnitude of the load received, and the semiconductor sensor is adapted to detect the load based on the resistance values of the piezo resistance elements which vary with the amount of displacement of the actuation diaphragm.

6. A method of manufacturing a semiconductor sensor, the method comprising the steps of:
preparing a semiconductor substrate;
forming a plurality of piezo resistance elements on one major surface of the semiconductor substrate;
forming an actuation diaphragm by subjecting the semiconductor substrate to an etching process from the other major surface of the semiconductor substrate;
forming metallic wiring lines on the one major surface of the semiconductor substrate to connect each of the piezo resistance elements to each other;
removing a part of the semiconductor substrate to form a frame outside the actuation diaphragm in a spaced-apart relationship with respect to the actuation diaphragm and a plurality of flexible beams for interconnecting the actuation diaphragm and the frame, each of the flexible beams having a plurality of piezo resistance elements formed on one major surfaces of the corresponding flexible beam; and
forming thermal stress absorbing portions on the other major surfaces of the respective flexible beams, the thermal stress absorbing portions being adapted to absorb thermal stresses developed in the beams due to the difference of coefficients of thermal expansion between the respective beams and the corresponding metallic wiring lines.

7. The method as claimed in claim 6, wherein the step of forming the thermal stress absorbing portions comprises the steps of:
forming a film on the other major surface of the semiconductor substrate in which the actuation diaphragm, the beams and the frame have been formed, the film being formed of a member selected from the group including metal, metal oxide and metal nitride; and
removing the film formed on the actuation diaphragm and the frame.

8. The method as claimed in claim 7, wherein the step of forming the film comprises one coating method selected from the group including a sputtering method, a vapor deposition method and a chemical vapor deposition method.

9. The method as claimed in claim 7, wherein the step of removing the film comprises an etching process.

10. The method as claimed in claim 6, further comprising the steps of:
bonding a glass substrate or a metal substrate to the other major surface of the semiconductor substrate after the step of forming the thermal stress absorbing portions; and
removing a part of the glass substrate or the metal substrate to form the frame and a weight member suspended from the plurality of flexible beams via the actuation diaphragm.
